(19) United States
(12) Patent Application Publication
(10) Pub. No.: US 2018/0373333 A1
(43) Pub. Date: Dec. 27, 2018

(54) METHOD OF DISPLAYING CHARACTERS FOR THE BLIND USING HAPTIC PATTERNS

(71) Applicant: Dong Hyun Park, Gangnam-gu, Seoul (KR)

(72) Inventor: Dong Hyun Park, Gangnam-gu, Seoul (KR)

(21) Appl. No.: 15/739,931

(22) PCT Filed: Jun. 2, 2016
(86) PCT No.: PCT/KR2016/005848

§ 371 Date: Dec. 26, 2017

(30) Foreign Application Priority Data
Jun. 29, 2015 (KR) 10-2015-0092024

(51) Int. Cl. G06F 3/01; G06F 3/044; G06F 3/0486; G06F 3/045

(52) U.S. Cl. CPC G06F 3/016; G06F 3/045; G06F 3/0486; G06F 3/044

(57) ABSTRACT

The present invention relates to method of displaying characters for the blind using haptic patterns, in which a user is allowed to recognize content displayed on a touch screen, even when a user conducts a scan at any position in any direction on the touch screen, by sensing an arbitrary touch position of the user on the touch screen to provide haptic patterns to a prescribed unit cell region generated around the sensed touch position, by sequentially and successively generating a unit cell at each interval along a trajectory of a touch and drag of the user to provide independent haptic patterns for each unit cell region, and by configuring to recognize a character symbol displayed on the touch screen through a combination of haptic patterns sequentially provided from the unit cells.

### TECHNICAL FIELD

The present disclosure relates to method of displaying characters for the blind using haptic patterns, and in particularly, to method of displaying characters for the blind using haptic patterns, in which content displayed on a touch screen, which has a touch panel configured to sense a touch position of a user and a haptic panel configured to provide haptic textures to a contacting body element and integrated to the touch panel, may be recognized by configuring to represent various character symbols through a combination of different haptic textures provided on the haptic panel, by sensing an arbitrary touch position of the user on the touch screen to provide haptic patterns to a prescribed unit cell region generated around the sensed touch position, by sequentially and successively generating a unit cell at each interval along a trajectory of a touch and drag of the user to provide independent haptic patterns for each unit cell region, and by configuring to recognize a character symbol displayed on the touch screen through a combination of haptic patterns sequentially provided at the unit cells, even when the user conducts a scan at any position in any direction on the touch screen.

### BACKGROUND ART

Recently, various kinds of electronic and mobile electronic devices such as a computer, a mobile communication terminal, a PDA, and a PMP are increasingly prevailed. Usages of such electronic devices determine whether to be able to access digital information, and such usages cause a new type of a digital divide. Since typical electronic devices are designed for a non-handicapped person who does not accompany any physical difficulty, however, it is not easy for a handicapped person to access such an electronic device.

Accordingly, various kinds of devices that may be used by a handicapped person are being developed, and various output devices among them are commercialized and provide information to the blind in a textile sensation.

For a typical braille display device, it is important to develop a device configured to provide driving power for withdrawal and activation of a braille pin in order to vertically move the braille pin. Korean patent registration no. 1,181,811 discloses a braille display in an actuator implementation type, which performs a vertical movement for driving withdrawal and actuation of a braille pin by sensing a braille output pin actuated on a braille cell and reading the braille with a haptic sensation of a finger base side.

However, when such an actuator is used, there is a difficulty in integrating solenoids in a small size as a braille output element, and thus there is also a difficulty in making a braille display device smaller. In addition, a high voltage is required to obtain sufficient generation power, a response speed is irregular and not fast, and durability is not good.

In order to address such difficulties, Korean patent application registration no. 1,305,235 invented by the inventors of the present invention discloses a technology capable of delivering an electric stimulus to a user' own body part that contacts a portion at which a user touches a touch screen and allowing the user to read a braille screen through the electric stimulus delivered to the user's own body part in a process where the user scans the touch screen with his/her finger.

However, in the above-described technology, in order to recognize one Braille alphabet, the user requires to sequentially scan, in a character U type, 6 detail areas (i.e. portions divided by dotted lines) provided in each dotted cell. On this account, it is disadvantageous in that a braille reading speed is getting slow and 6 divided printing areas are required to display one braille alphabet, and thus the number of brailles providable in a restricted screen area at the same time is significantly limited.

In addition, the user may recognize a text through a combination of brailles displayed on the touch screen only by sequentially scanning in one direction and starting from a specific position (i.e. a first dotted cell in a first row) on the touch screen so as to recognize a braille displayed on the touch screen, and thus, the user typically feels inconvenient to search for a start position fixed on the touch screen. Unlike a physically composed button type, the user is not able to recognize a haptic sensation from the touch screen, and thus, it is not easy for the blind to search for a fixed start position. Even in a case where a moving direction of a hand is dislocated from a scan area in a process of scanning the touch screen, the blind does not frequently perceive this and misreads a text.

### DISCLOSURE

### Technical Problem

Various embodiments are directed to method of displaying characters for the blind using haptic patterns, in which a user may recognize content displayed on a touch screen by sensing an arbitrary touch position of the user on the touch screen to provide haptic patterns to a prescribed unit cell region generated around the sensed touch position, by sequentially and successively generating a unit cell at each interval along a trajectory of a touch and drag of the user to provide independent haptic patterns for each unit cell region, and by configuring to recognize characters symbol displayed on the touch screen through a combination of haptic patterns sequentially provided at the unit cells, even when the user conducts a scan at any position in any direction on the touch screen.

### Technical Solution

As a technical idea for achieving the above-described purpose, the present disclosure provides method of displaying characters for the blind using haptic patterns, in which haptic patterns are delivered to a unit cell generated with a preset size around the sensed touch position by sensing the touch position of a user on the touch screen, independent haptic patterns are configured to be provided for each generated unit cell by sequentially and successively generating a unit cell region at a preset interval along a trajectory generated from a movement of a touch and drag of the user, and the user recognizes text information displayed on the touch screen by perceiving haptic patterns delivered to his/her own body element for each of the successively generated unit cells through scanning of the touch screen with the his/her own body element and by representing, as characters symbol forming a text, a combination of haptic patterns sequentially and respectively provided from the successively generated unit cells.

### Advantageous Effects

Method of displaying characters for the blind using haptic patterns according to present invention allows a user to be able to recognize content displayed on a touch screen, even when the user scans the touch screen at any position in any direction.

Accordingly, the user does not have to search for a separate scan start position in order to recognize a text displayed on the touch screen, and when a unit cell region is sequentially and successively generated at a certain interval along a trajectory generated from a movement of a user's touch and drag and independent haptic patterns are provided in each unit cell region, the user may successively and conveniently scan text information regardless of the start position or scan direction. Therefore, the user may effectively recognize the text information without being limited to a restricted screen area of the touch screen.

### BRIEF DESCRIPTION OF DRAWINGS

FIG. 1 is a diagram illustrating a configuration of a touch screen to which method of displaying characters for the blind using haptic patterns is applied in accordance with an embodiment of the present disclosure.

FIG. 2 is a diagram illustrating an example of generating a unit cell region by sensing a touch position of a user in accordance with an embodiment of the present disclosure.

FIG. 3 is a diagram illustrating an example of sequentially and successively generating unit cell regions along a trajectory of a touch and drag of the user in accordance with an embodiment of the present disclosure.

FIG. 4 is a diagram illustrating examples of haptic textures provided from a unit cell in accordance with an embodiment of the present disclosure.

FIG. 5 is a diagram illustrating an example in which independent haptic patterns are provided in each unit cell region generated by sensing the touch position of the user in accordance with an embodiment of the present disclosure.

FIG. 6 is a diagram illustrating an example of characters symbol combination system for haptic patterns in accordance with an embodiment of the present disclosure.

FIG. 7 is a diagram illustrating method of displaying characters for the blind using haptic patterns in accordance with an embodiment of the present disclosure.

### MODE FOR INVENTION

Hereafter, exemplary embodiments of the present invention will be described in detail with reference to the accompanying drawings.

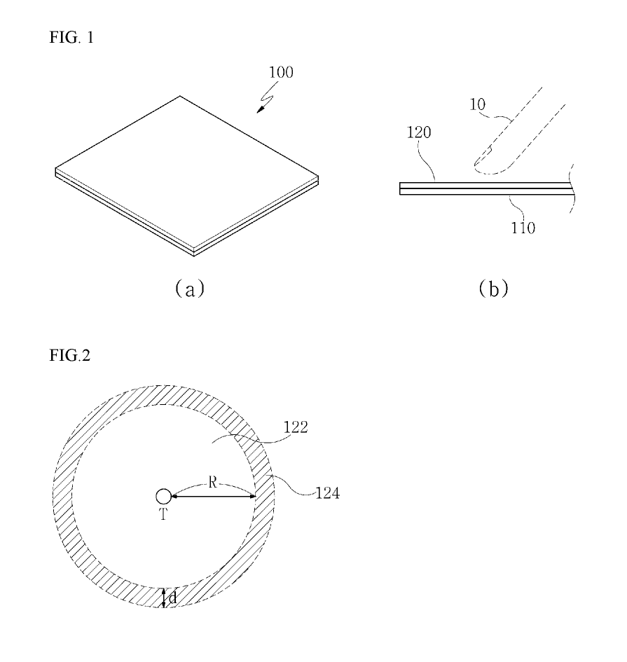

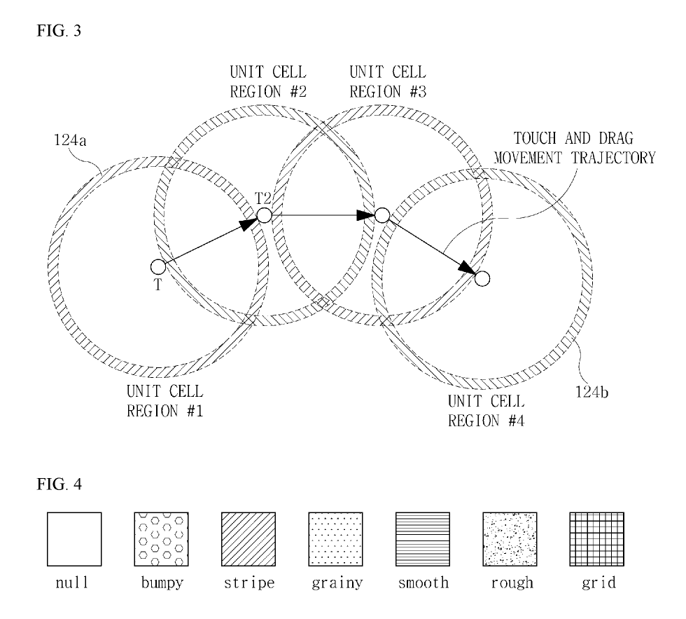

FIG. 1 is a diagram illustrating a configuration of a touch screen to which method of displaying characters for the blind using haptic patterns is applied, in accordance with an embodiment of the present disclosure. FIG. 2 is a diagram illustrating an example of generating a unit cell region by sensing a touch position of a user in accordance with an embodiment of the present disclosure. FIG. 3 is a diagram illustrating an example of sequentially and successively generating unit cell regions along a trajectory of a touch and drag of the user in accordance with an embodiment of the present disclosure.

As shown in FIG. 1, a touch screen 100 in accordance with an embodiment of the present disclosure integrally includes a touch panel 110 configured to provide a screen and sense a touch position of a user, and a haptic panel 120 that is provided on an upper part of the touch panel 110 and configured to provide haptic textures to a contacting body part of the user.

The touch panel 110 functions to sense the touch position of the user, and may be configured from one of various types of touch panels, e.g., a capacitive type, an infrared type, a resistive type, or an ultrasonic type. When a user's body part such as a finger touches the touch panel 110, the touch panel 110 senses the same and determines the touch position of the user.

The haptic panel 120 is closely provided in the upper part of the touch panel 110. When the finger of the user touches a panel surface and the touch panel 110 senses the same, the haptic panel 120 functions to transmit haptic patterns based on the position at which the touch of the user is conducted, to the finger of the user.

Various types of panels may be used as the haptic panel 120. For example, there is an electro-sensitive panel which is formed of conductive electrodes with an insulator and configured to generate an electric signal based on a touch position on a panel surface and thus provide an electrical stimulation pattern to a contacting body part of the user.

In the following description of the embodiment, the electro-sensitive panel will be used as an example of the haptic panel of the present disclosure. The electro-sensitive panel generates an electric signal based on the touch position on the panel surface and thus provides an electrical stimulation pattern to the contacting body part of the user. The electrical stimulation pattern generated from the electro-sensitive panel may be changed in various ways by changing a parameter such as a voltage, a current, a wavelength, a frequency, or a waveform of the electric signal. Depending on a generated electrostatic waveform, the haptic sensation of the finger is changed into a rough sensation, a smooth sensation, etc., so that various haptic patterns may be embodied. However, the haptic panel of the present disclosure is not limited to the electro-sensitive panel, and various types of haptic panels capable of providing different haptic textures to the contacting body part of the user. For instance, the haptic panel of the present disclosure may also be applied to a scheme, which is recently being developed and in which haptic patterns are embodied by outputting vibration resulting from driving of a film type actuator.

The touch screen 100 of the present disclosure may provide, when a touch position of the user is sensed on the touch screen, haptic patterns to a unit cell region generated around the sensed touch position, sequentially and successively generate unit cell regions at a certain interval along a trajectory generated from movements of a user's touch and drag, and provide independent haptic patterns to each of the successively-generated unit cell regions. Consequently, regardless of the position at which the user touches and scans the touch screen, the user may perceive the haptic patterns sensed by his/her finger and sequentially recognize content displayed on the touch screen.

In other words, as illustrated in FIG. 2, when the user touches an arbitrary position, a circular unit cell region 122 with a radius R of a preset size is formed around the touched coordinates T, and haptic patterns are provided to the formed unit cell region. Then, as illustrated in FIG. 3, when the user moves his/her finger in a touch and drag type and the user's touch position is dislocated from the formed first unit cell region, the first unit cell region disappears, a touch point of the user, which is dislocated from the first unit cell region, is designated as new coordinates T2. Then, a second unit cell region with a radius R of a certain size is formed which has the newly designated coordinates T2 as a center point, and haptic patterns corresponding to the second unit cell is provided.

In this way, by repeating processes of tracing the touch position of the user, generating the unit cell sequentially and successively, and delivering the independent pattern to the user' finger for each unit cell, the user may sequentially perceive the haptic patterns delivered to his/her own finger regardless of a scan direction, and recognize content displayed on the touch screen.

At this point, in order to further accurately support user's recognition of the haptic patterns, a unit cell discriminating region 124 with a certain interval d may be formed in each individual unit cell region 122 along an outer circumference, and, to the unit cell discriminating region 124 formed in this way, preset specific electric stimulus patterns 124a and 124b such as a scratch type may be provided to clearly discriminate each unit cell region 122.

Furthermore, the size of the unit cell region 122 formed around the touched coordinates T may be within a radius in which the thumb or index finger of a hand of the user may move horizontally or vertically. Accordingly, the user may perceive haptic patterns delivered to his/her finger only just with successive horizontal or vertical movements of the thumb or index finger, recognize content displayed on the touch screen, and also successively scan text information even on a touch screen with a very small size.

FIG. 4 is a diagram illustrating examples of haptic textures provided from the unit cell in accordance with an embodiment of the present disclosure.

As illustrated in FIG. 4, when the user's finger touches the touch screen, cells existing at the position at which the user's finger touches generate electric signals to provide electric stimuli to the user's finger, and different haptic textures such as a bumpy, stripe, grainy, smooth, and rough haptic sensation, or null sensation through which no haptic sensation is felt may be provided for each cell according to modification of a voltage, a current, a wavelength and frequency, or a waveform, etc. Accordingly, when scanning the touch screen with his/her finger, the user may recognize an independent haptic texture for each unit cell through the haptic sensation.

In particular, the present disclosure provides various kinds of text information by providing different haptic textures through an independent electric stimulus pattern for each unit cell region in this way, and representing one character symbol through a combination of a pair of unit cells formed successively. Hereinafter, a description will be provided about method of displaying characters for the blind using 7 haptic textures illustrated in FIG. 4 according to an embodiment of the present disclosure.

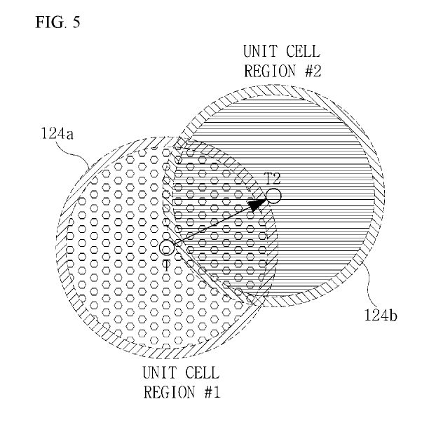

FIG. 5 is a diagram illustrating an example in which independent haptic patterns is provided for each unit cell region generated by sensing the touch position of the user in accordance with an embodiment of the present disclosure.

First, when the user touches an arbitrary position on the touch screen, a unit cell region with a preset size is formed around touched coordinates and haptic patterns corresponding to the formed unit cell region is provided. Then, when the user moves his/her finger in a touch and drag type and the touch position of the user is dislocated from the formed unit cell region, a touch point of the user, which is dislocated from the unit cell region, is designated as new coordinates, a new unit cell region with the preset size is formed around the new coordinates, and new haptic patterns corresponding to the new unit cell region are delivered.

In other words, through two unit cell regions successively formed by a touch and drag by the user, different haptic patterns may be provided through independent electric stimulus patterns in respective unit cells, and therefore, various character symbols such as a Korean alphabet, an English alphabet, a number, and a special character may be represented in a pair of unit cells through a combination of various haptic textures provided from the two successively formed unit cells.

For example, as illustrated in FIG. 5, when the user touches an arbitrary position on the touch screen, a unit cell region with a preset size is formed with touched coordinates as a center point, and an electric stimulus ‘bumpy’ is delivered to the user's finger in the formed unit cell. Then, when the user moves his/her finger in a touch and drag type and the touch position of the user is dislocated from the formed unit cell region, the previously formed unit cell region disappears, a touch point of the user, which is dislocated from the unit cell region, is designated as new coordinates, a second unit cell region with the preset size is formed around the new coordinates, and an electric stimulus ‘smooth’ is delivered to the user's finger in the formed unit cell.

Accordingly, the user may sequentially perceive each unit cell successively formed through the touch and drag, and then recognize the pair of unit cells composed of ‘bumpy’ and ‘smooth’ displayed on the touch screen. When it is agreed that the pair of unit cells composed of the ‘bumpy’ and ‘smooth’ mean a Korean alphabet ‘ [symbol] ’, the user may read the Korean alphabet ‘ [symbol] ’ through the scan process.

In this way, a character symbol such as a Korean alphabet, an English alphabet, a number, or a special character may be represented through a pair of unit cells, and, by means of a combination thereof, various text combination systems for a haptic screen may be generated.

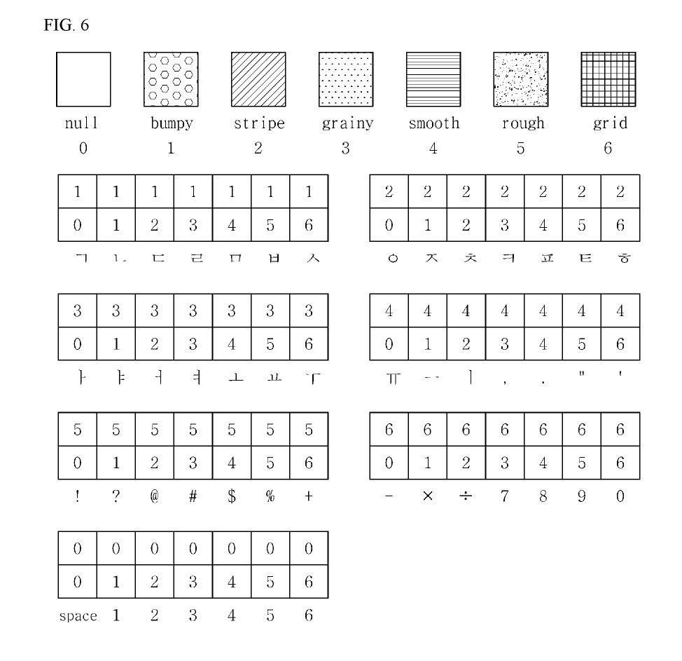

For example, as illustrated in FIG. 4, when the null through which no haptic sensation is felt indicates 0, a bumpy haptic sensation 1, a stripe haptic sensation 2, a grainy haptic sensation 3, a smooth haptic sensation 4, a rough haptic sensation 5, and a grid type haptic sensation 6, each of 7 unit cells represents different textures and thus 7*7=49 character cells may be combined through a pair of unit cells. FIG. 6 shows an example of a text combination system for haptic patterns screen in which Korean alphabets and numbers are represented by using the 49 combinations of the pair of unit cells.

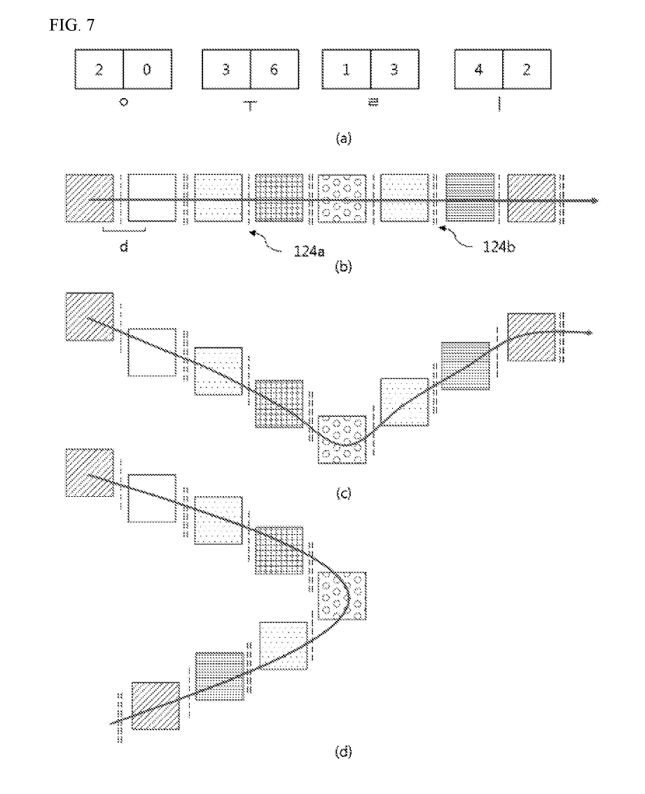

FIG. 6 is a diagram illustrating an example of a character symbol combination system for haptic patterns in accordance with an embodiment of the present disclosure, and FIG. 7 is a diagram illustrating method of displaying characters for the blind using haptic patterns in accordance with an embodiment of the present disclosure.

Like FIG. 7(a), when it is assumed that a text ‘we’ is displayed on the touch screen according to FIG. 6, the user touches an arbitrary point on the touch screen, and then proceeds in a desired direction and sequentially scans. At this point, a touch screen forms a unit cell region with a preset size around the touch point of the user, and a ‘stripe’ haptic pattern is delivered to the user's contacting finger in the formed unit cell. Then, when the user moves his/her finger in a touch and drag type and the user's touch position is dislocated from the formed first unit cell, a second unit cell region with the preset size is formed around the user's touch point that is dislocated from the first unit cell region, and a ‘null’ haptic pattern is delivered to the user's contacting finger in the formed second unit cell.

At this point, like FIG. 7 (b), in the first unit cell region and the second unit cell region, when scratch type electric stimulus patterns 124a and 124b are delivered through a unit cell discriminating region having a certain interval d along the circumference of the unit cell region such that respective unit cell regions are discriminated from each other, the user may feel an independent haptic texture in each unit cell, even when an identical haptic pattern is successively delivered. Through this, the user may cognize a Korean alphabet ‘ [symbol] ’.

In this way, through the touch and drag, the user may sequentially scan unit cells that has been successively generated at a certain interval, and read text ‘we’ displayed on the touch screen through the electric stimulus delivered to the touching finger for each unit cell.

In particular, as illustrated in FIG. 7(c) or 7(d) in the present disclosure, each unit cell region is sequentially and successively generated at a certain interval along a movement trajectory of the user's touch and drag around an arbitrary touch start point by the user regardless of a moving direction, and independent haptic patterns are provided for each unit cell. Accordingly, even when the user scans the touch screen by touching any position on the touch screen and dragging in any desired direction, the user may perceive haptic patterns delivered to his/her finger and sequentially recognize content recorded on the touch screen.

In an embodiment illustrated in FIG. 6, a pair of unit cells, which are successively generated with 7 haptic textures, represent 7 different haptic textures, and thus Korean alphabets and numbers are represented through total 49 different combinations. However, the present disclosure is not limited thereto, and it is also possible to conduct more text combinations such as English alphabets, numbers, and special symbols as well as various haptic patterns.

In addition, FIG. 6 is just an embodiment of method of displaying characters for the blind using haptic patterns, and the present disclosure is not limited thereto. Furthermore, if haptic patterns electronic file provider and a user could only agree, various haptic pattern systems may be provided.

On the other hand, text information of the present disclosure is sequentially and successively provided according to a moving distance regardless of a movement direction of a user's finger, and therefore, the user could consecutively scan text information if the user does not release a touch from the touch screen. In other words, when the user touches a finger at an arbitrary position on the touch screen and drags to move the finger in any desired direction in a state where the user does not release the finger from the touch screen, haptic patterns for representing a character symbol is delivered based on the movement of the finger and the user may perceive the haptic patterns delivered to his/her own finger to sequentially recognize content recorded on the touch screen.

In other words, the user may further conveniently recognize content displayed on the touch screen through a natural motion such as a back-and-forth motion of his/her own finger contacting the touch screen.

Furthermore, such text information may be a Korean sentence and the user may perceive each Korean alphabet through a plurality of haptic patterns that are sequentially provided, and may perceive phrases and the sentence through a combination of the perceived Korean alphabets. In other words, only if a user sequentially perceives from haptic patterns corresponding to a first Korean alphabet of a phrase, the user may combine one phrase and then perceive a sentence combined from a plurality of phrases.

Accordingly, in the present embodiment, a text information provision criterion of a user is divided and provided in a phrase unit. In other words, in the present embodiment, when the user releases the touch from the touch screen during scanning of a text, a unit cell region in which haptic patterns have been delivered disappears, and when the user retouches the touch screen, a unit cell region is again generated around a touch position of the user and haptic patterns are delivered. At this point, text information at the time of retouching by the user is sequentially provided starting again from haptic patterns corresponding to a first character symbol of a first character of a phrase that has been being scanned before the release of the touch.

In other words, when it is assumed that the user scans a sentence let me invite you to my home' and the user releases a touch during scanning of ‘let’ at the time of retouching, the user is sequentially provided again from haptic patterns corresponding to a first alphabet of ‘let’. When the user releases the touch during scanning of ‘home’, at the time of retouching, the user is sequentially provided again from haptic patterns corresponding to a first alphabet of ‘home’. Accordingly, even when releasing a touch during scanning, at the time of retouching, the user may accurately and subsequently perceive text information that he or she has been scanning.

Furthermore, the present invention may provide a moving function in a phase unit, a sentence unit and/or a paragraph unit of text information through a separate key button and/or recognition of user's gesture such that the user may more effectively control provision of text information that is scanned by himself/herself. For example, the moving function may be provided such that the user is able to move by a phase unit, a sentence unit and/or a paragraph unit of the text information that is scanned by himself/herself by including a separate key button for providing haptic textures at a fixed side of the touch screen or a separate key button unit at an outskirt of the touch screen. Above this, when the user shortly touches the touch screen twice and then moves a finger horizontally without releasing the finger, the user may be allowed to move by a phase unit of the text information, and when the user touches the touch screen with two fingers and vertically moves the fingers, the user may be allowed to move by a sentence unit. In this way, the moving function in the text information may also be allowed through recognition of a user's gesture.

As describe above, in the present disclosure, even when scanning a touch screen at any position in any direction, the user may recognize content displayed on the touch screen. Accordingly, the user does not have to search for a separate scan start position in order to recognize a text displayed on the touch screen. In addition, as a unit cell region is sequentially and successively generated at a certain interval along a trajectory generated from movements of a user's touch and drag and independent haptic patterns are provided for each unit cell region, the user may successively and conveniently scan text information regardless of the start position or scan direction. Therefore, the user may effectively recognize the text information without being limited to a restricted screen area of the touch screen.

The above-described present disclosure is not limited to the above-described embodiments and the accompanying drawings, and those having ordinary skill in the technical field to which the present disclosure pertains can make various replacements, variations and modifications without departing from the technical spirit of the present disclosure.

While various embodiments have been described above, it will be understood to those skilled in the art that the embodiments described are by way of example only. Accordingly, the disclosure described herein should not be limited based on the described embodiments.

### INDUSTRIAL APPLICABILITY

According to method of displaying characters for the blind using haptic patterns, the user may recognize content displayed on the touch screen even when a touch screen is scanned at any position in any direction. Accordingly, the user does not have to search for a separate scan start position so as to recognize a text displayed on the touch screen. Furthermore, since a unit cell region is sequentially and successively generated at a certain interval along a trajectory generated from movements of a user's touch and drag and independent haptic patterns are provided for each unit cell region, the user may successively and conveniently scan text information regardless of the start position or scan direction, and may effectively recognize the text information without being limited to a restricted screen area of the touch screen.

1. Method of displaying characters for the blind using haptic patterns, which is provided on a touch screen in which a touch panel configured to sense a touch position of a user and a haptic panel associated with the touch panel and configured to deliver haptic patterns to a contacting body element of the user are integrated, the method comprising:
sensing the touch position of the user on the touch screen and delivering haptic patterns to a unit cell generated with a preset size around the sensed touch position;
sequentially and successively generating a unit cell region at a preset interval along a trajectory generated from a touch and drag movement by the user and providing independent haptic patterns for each generated unit cell; and
representing, as a character symbol forming a text, a combination of haptic patterns sequentially and respectively provided from the successively generated unit cells, and recognizing, by the user, text information displayed on the touch screen by perceiving haptic patterns delivered to a user's own body element for each of the successively generated unit cells through scanning of the touch screen with the user's own body element.

2. The method of claim 1, wherein the unit cell region is formed in a circular region having a preset sized radius with coordinates of the sensed touch position as a new center point.

3. The method of claim 2, wherein in the unit cell, a unit cell discriminating region is formed along an outer circumference of the unit cell.

4. The method of claim 3, wherein preset specific haptic patterns are provided to the unit cell discriminating region.

5. The method of claim 1, wherein in the sequentially and successively generating of the unit cell region along the trajectory of the touch and drag movement by the user, when a touch position of the user through the touch and drag movement by the user is dislocated from a unit cell region generated in advance, the touch position of the user, which is dislocated from the unit cell, is designated as new coordinates and a new unit cell region is generated with the designated new coordinates as a center point.

6. The method of claim 5, wherein, when the new unit cell is generated, the unit cell region generated in advance disappears.

7. The method of claim 1, wherein the haptic patterns comprise seven different haptic sensations of null through which no haptic sensation is felt, a bumpy haptic sensation, a stripe haptic sensation, a grainy haptic sensation, a smooth haptic sensation, a rough haptic sensation, and a grid type haptic sensation.

8. The method of claim 1, wherein the character symbol comprises a Korean alphabet, an English alphabet, a number, and/or a special character.

9. The method of claim 1, wherein the representing of the character symbol through the combination of the haptic patterns is performed through a combination of haptic patterns respectively and independently delivered at two successively generated unit cell regions.

10. The method of claim 1, wherein when the user temporally releases a touch from the touch screen and retouches the touch screen, the text information is provided again from a first character symbol of a phrase that has been being scanned by the user before releasing of the touch.

11. The method of claim 1, wherein a function is further provided which provides a movement by a phase unit, a sentence unit, and/or a paragraph unit of text information displayed on the touch screen through recognition of a user's gesture, which is delivered through a contacting body element of the user.

12. The method of claim 1, wherein a function is further provided which provides a movement by a phase unit, a sentence unit, and/or a paragraph unit of text information displayed on the touch screen according to a button input by the user through a separate key button unit, when the separate key button unit for a movement of text information displayed on the touch screen is further provided on the touch screen.
